(19) United States
(12) Patent Application Publication
(10) Pub. No.: US 2025/0139493 A1
(43) Pub. Date: May 1, 2025

(54) PRE-TRAINED LANGUAGE MODELS INCORPORATING SYNTACTIC KNOWLEDGE USING OPTIMIZATION FOR OVERCOMING CATASTROPHIC FORGETTING

(71) Applicant: International Business Machines Corporation, Armonk, NY (US)

(72) Inventors: RAN KIMURA, Kawasaki (JP); Issei Yoshida, Tokyo (JP); HIROSHI KANAYAMA, Yokohama-shi (JP); Takuya Ohko, TOKYO (JP); Masayasu Muraoka, Tokyo (JP)

(21) Appl. No.: 18/385,669

(22) Filed: Oct. 31, 2023

(51) Int. Cl. G06N 20/00; G06N 5/04

(52) U.S. Cl. CPC G06N 20/00; G06N 5/04

(57) ABSTRACT

A syntactic pre-training task is selected from among a set of syntactic pre-training tasks. For the selected syntactic pre-training task, the pre-trained language model is retrained by using an optimization function which prevents catastrophic forgetting during the retraining. Inferencing is performed using the retrained language model.

### BACKGROUND

The present invention relates generally to the electrical, electronic and computer arts and, more particularly, to machine learning.

Syntactic knowledge is invaluable information for many tasks which handle complex and long sentences, but pre-trained language models (such as a Bidirectional Encoder Representations from Transformers (BERT)) do not contain sufficient syntactic knowledge. Thus, the pre-trained language models may produce syntactically unnatural output when the models are applied to downstream tasks, such as phrase extraction.

### BRIEF SUMMARY

Principles of the invention provide systems and techniques for pre-trained language models incorporating syntactic knowledge using optimization for overcoming catastrophic forgetting. In one aspect, an exemplary method includes the operations of selecting, using at least one hardware processor, at least one syntactic pre-training task from among a set of syntactic pre-training tasks; retraining, for the selected at least one syntactic pre-training task and using the at least one hardware processor, the pre-trained language model by using an optimization function which prevents catastrophic forgetting during the retraining; and performing, using the at least one hardware processor, inferencing using the retrained language model.

In one aspect, a computer program product comprises one or more tangible computer-readable storage media and program instructions stored on at least one of the one or more tangible computer-readable storage media, the program instructions executable by a processor, the program instructions comprising selecting at least one syntactic pre-training task from among a set of syntactic pre-training tasks; retraining, for the selected at least one syntactic pre-training task, the pre-trained language model by using an optimization function which prevents catastrophic forgetting during the retraining; and performing inferencing using the retrained language model.

In one aspect, an apparatus comprises a memory and at least one processor, coupled to the memory, and operative to perform operations comprising selecting at least one syntactic pre-training task from among a set of syntactic pre-training tasks; retraining, for the selected at least one syntactic pre-training task, the pre-trained language model by using an optimization function which prevents catastrophic forgetting during the retraining; and performing inferencing using the retrained language model.

As used herein, “facilitating” an action includes performing the action, making the action easier, helping to carry the action out, or causing the action to be performed. Thus, by way of example and not limitation, instructions executing on a processor might facilitate an action carried out by instructions executing on a remote processor, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
improvements to the technological process of machine learning by embedding syntactic knowledge into pre-trained language models, without changing the format of the model, toward the goal of adding syntactic knowledge while retaining semantic knowledge using a specific optimization function;
reduces or eliminates catastrophic forgetting in machine learning when using pretrained models (especially, but not limited to, small pretrained models), such as BERT, robustly optimized BERT (ROBERTa), and the like, and thereby increases accuracy; and
improvements to the technological process of machine learning by providing numerous tasks for pre-training with syntactic knowledge.

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is an overview of syntactic pre-training, in accordance with an example embodiment;

FIG. 2A is a table of four example syntactic pre-training tasks, in accordance with an example embodiment;

FIG. 2B is a table showing a comparison with different syntactic tasks and optimization functions in syntactic pre-training, in accordance with an example embodiment;

FIG. 2C is a table of sentences in the conventional English treebank corpus (after filtering) used for syntactic pre-training, in accordance with an example embodiment;

FIG. 2D is a table showing performance comparisons of three General Language Understanding Evaluation (GLUE) tasks based on syntactic pre-training and optimization functions, in accordance with an example embodiment;

FIG. 2E is a table showing a comparison of model average for each optimization function in three GLUE tasks and showing the model scores of each optimization function averaged over the four pre-training tasks shown in the table of FIG. 2D, in accordance with an example embodiment;

FIG. 2F is a table showing a comparison of model average for each syntactic pre-training in three GLUE tasks and showing the model scores of each pre-training task averaged over the optimization functions shown in the table of FIG. 2D, in accordance with an example embodiment;

FIG. 2G is a table showing a performance comparison of a key phrase extraction task, in accordance with an example embodiment;

FIG. 2H is a table of the statistics in a conventional scholarly articles small dataset, in accordance with an example embodiment;

FIG. 2I is a table showing a comparison of average scores of syntactic pre-trained models in the key phrase extraction, in accordance with an example embodiment;

FIG. 3 is a first example phrase output, in accordance with an example embodiment;

FIG. 4 is a second example phrase output, in accordance with an example embodiment; and

FIG. 5 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

Pre-trained neural language models are becoming more commonly used and improve the performance of a variety of complex application tasks. Recent studies have shown that incorporating syntactic knowledge into the models further improves the performance of reading comprehension, language understanding, and translation tasks. It has also been shown that pre-trained language models roughly capture syntactic knowledge, such as part-of-speech and dependency structures, but they lack some syntactic knowledge, such as dependency distance and head token required for application tasks.

Most of the aforementioned studies incorporate syntactic information explicitly by adding other modules to the core model in the training and application phases, which alters the model output format. However, many applications assume that the model format should be unchanged so that the model can be used in the same way as publicly available pre-trained models, and hence the unique format of the model causes difficulty in applying it to other downstream tasks.

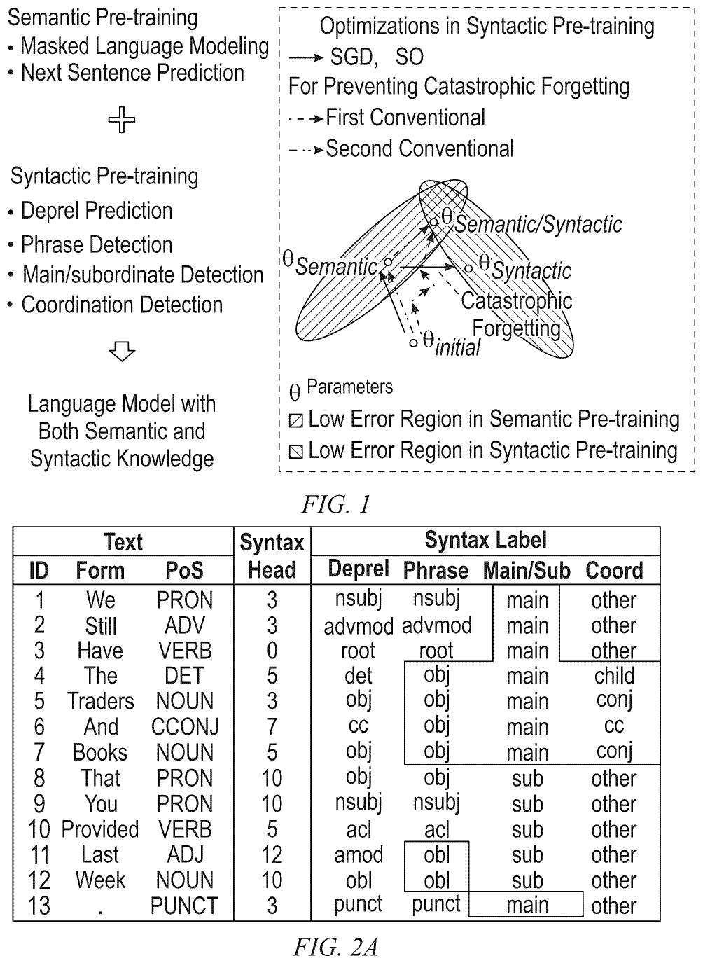

How syntactic knowledge can be effectively embedded into a standard language model without changing its model format toward the goal of adding syntactic knowledge while retaining semantic knowledge is thoroughly analyzed below. A general framework for training a model (see FIG. 1) is described. First, a model is trained with a large amount of unlabeled text data and standard tasks, such as Masked Language Modeling. This is called semantic pre-training. Next, the trained model is fine-tuned with additional information and tasks for syntactic knowledge, which is called syntactic pre-training herein. After syntactic pre-training, the resultant model is expected to contain both semantic and syntactic knowledge. Note that the resultant model typically has exactly the same model format as the semantic one.

Some studies also take this approach to embed syntactic knowledge into a model. However, a pertinent technical issue in this framework is that, when a model trained by semantic pre-training is then trained by syntactic pre-training, catastrophic forgetting may prevent the model from keeping the semantic information. To tackle this problem, two optimization functions are introduced to suppress catastrophic forgetting. One or more embodiments advantageously provide an analysis of how both the types of syntactic information and optimization functions affect the performance of downstream tasks is believed to be the first of its kind.

In example embodiments, four syntactic pre-training tasks are utilized to incorporate syntactic knowledge. We have found that effective syntactic information that the model keeps is significantly different among the tasks. We have also found that the effectiveness of syntactic information depends significantly on downstream tasks. In example embodiments, two optimization functions that prevent catastrophic forgetting during the syntactic pre-training process are exploited. Experimental results show that conventional optimization methods outperform a conventional stochastic optimization method and a conventional stochastic gradient descent (SGD) method.

We have also found that models containing both original semantic knowledge and additional syntactic knowledge achieved high performance on a conventional decentralized training algorithm, on textual entailment (RTE), on a mendelian randomization PC algorithm (MRPC), and on key phrase extraction tasks.

### Syntactic Pre-Training

FIG. 1 is an overview of syntactic pre-training, in accordance with an example embodiment. Syntactic knowledge is added to the language model while preserving the original semantic knowledge in the model using proper optimization functions. In syntactic pre-training, models mainly learn syntactic relationships between two tokens. There have been proposed tasks, such as predicting dependencies, predicting parent-child, sibling, or cousin relationships, and dependency distance. The dependency structure encompasses a variety of word relationships, a number of which are important in application tasks and/or human language understanding.

For example, in real-world tasks, such as noun phrase extraction and sentiment analysis, the relationship between main and subordinate clauses and parallel structures are not handled well. To reflect the syntactic knowledge missing and required for downstream tasks in pre-trained models, one or more embodiments helpfully perform more diverse syntactic prediction tasks.

Four pre-training tasks were therefore developed to predict various syntactic items. Each task predicts specific syntactic information: 1) deprel prediction, 2) phrase detection, 3) main/subordinate detection, and 4) coordination detection. The task that would be effective on application tasks was also investigated.

### Syntactic Pre-Training System

In one example embodiment, the system learns two tasks in parallel: dependency masking (DM), which predicts whether there is a dependency between two words, and masked dependency prediction (MDP), which predicts the type of dependency relationships. The input for MDP is replaced with one of four pre-training tasks.

### Syntactic Pre-Training Task

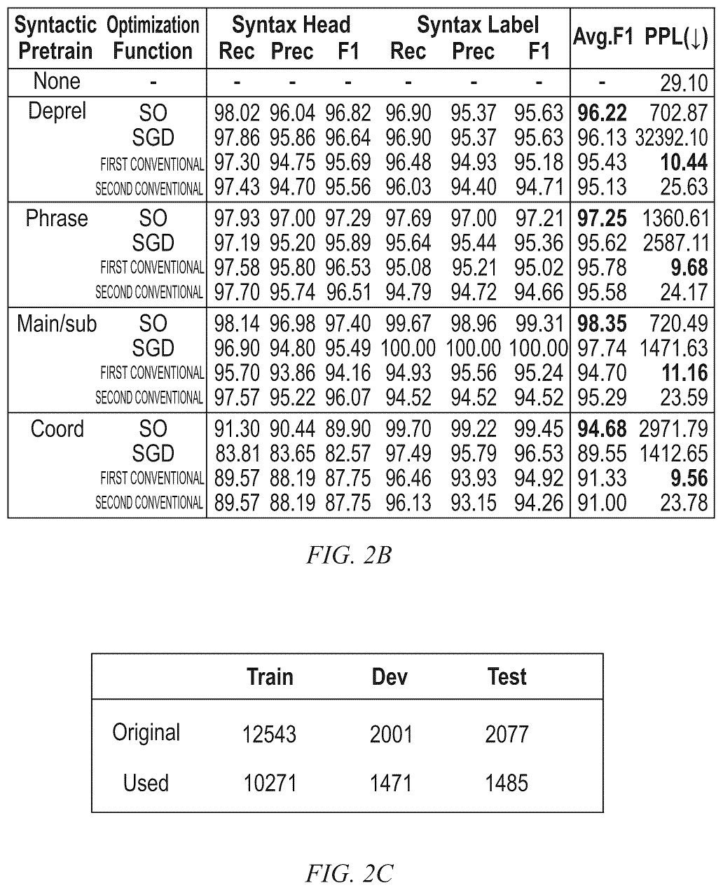

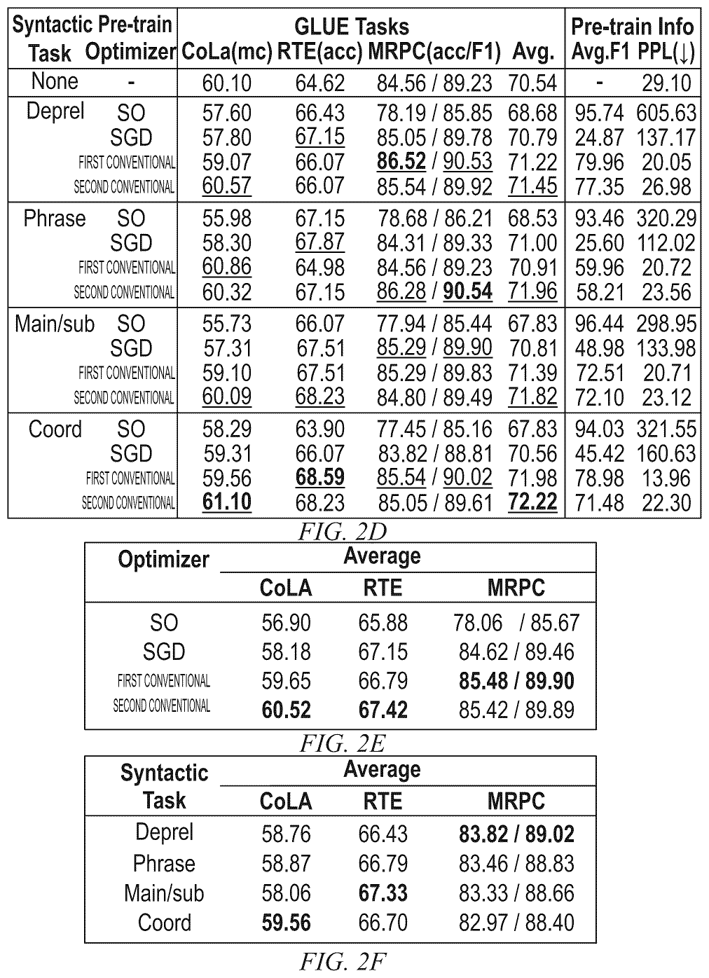

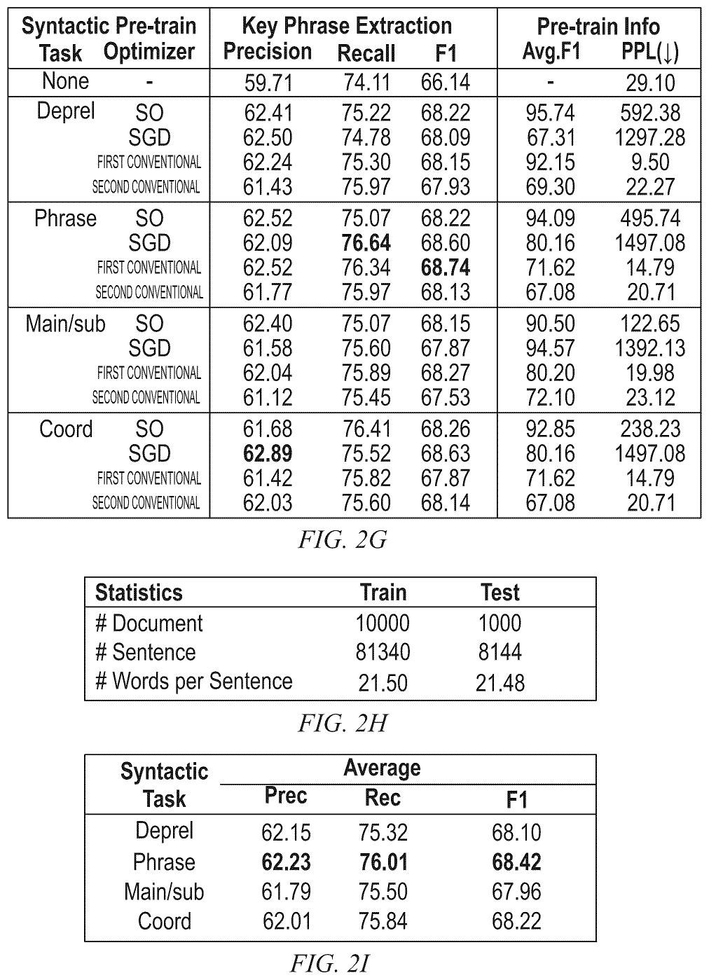

FIG. 2A is a table of four example syntactic pre-training tasks, in accordance with an example embodiment. (Gray areas denote phrases, main clauses, and coordination structures.) In one prior art system, the model learns Syntax Head and Syntax Label simultaneously. Syntax Head conveys the form of dependency tree, which is used for DM in the system described in the section entitled “Syntactic Pre-training System” and, since the dependency tree is common/general information in syntactic knowledge, it was fixed in example embodiments to allow models to learn the general knowledge. As MDP, the viewpoint of syntax classification is varied with the following four labeling tasks.

### Deprel Prediction (Deprel)

In deprel prediction, the model predicts dependency labels. For syntactic pre-training tasks, this task is positioned as a baseline.

### Phrase Detection (Phrase)

In this task, the model predicts the relationship between phrases (the deprel label of the head token in the phrase). Here, the conventional definition of phrase (nucleus) is employed. A known prior art model achieved high performance in dependency parsing by nucleus-level pre-training, which are phrase-like units, and defined the nucleus as the block connected by seven UD functional relations, such as a determiner and case marker.

### Main/Subordinate Detection (Main/Sub)

Here, the task predicts two labels to classify clauses into main and subordinate. Note that given the teachings herein, known techniques can be adapted to investigate whether pre-trained model can detect subordinate clauses.

### Coordination Detection (Coord)

Coordination detection aims to predict parallel structures, like “A and B” where A and B can be tokens, phrases, or sentences. Specifically, it predicts the labels of A and B's head tokens (conjunction), their child tokens (child), parallel conjunctions, such as “and” and “but” (cc), and other tokens (other).

### Optimization Functions to Prevent Catastrophic Forgetting

Two optimization functions that prevent catastrophic forgetting are described below. When the model has already been trained for a specific task and then trained for another task, the performance of the previous task significantly decreases. This is called catastrophic forgetting.

Although large-scale pre-trained models are known to be relatively resilient to catastrophic forgetting, the problem remains when using small models such as BERT. Since BERT is still often used in real-world tasks due to computational resources, a variety of methods are developed to prevent catastrophic forgetting even in pre-trained models, such as decreasing the learning rate. Among these methods, a first conventional optimization method known in the domain of multi-task learning and a second conventional optimization method commonly used in continual learning were used.

### First Conventional Optimization Method

The first conventional optimization method is an optimization method for solving gradient conflicts in multi-task learning. It first computes the gradients for each task involved in the multi-task learning. Adversarial elements of the gradients that conflict with each other are then discarded. After that, the resultant gradients are summed up to obtain a single gradient vector. For example, given two tasks A and B, if their gradient vectors g_{A} and g_{B} are in opposite directions (i.e., if the cosine similarity of g_{A} and g_{B} is negative), one gradient g_{A} is projected onto the orthogonal plane of the other gradient g_{B} as follows:

$${g}_{A} = {g}_{A} - \frac{{g}_{A} \cdot {g}_{B}}{{‖ {g}_{B} ‖}^{2}} {g}_{B} ,$$

where ∥x∥ denotes L2-norm of x.

### Second Conventional Optimization Method

The second conventional optimization method is a continuous learning optimization method in which tasks are learned in sequence. Given two tasks, A and B, the model first searches for the optimal solution for task A, and then searches for the parameters that perform well in both tasks A and B. In the second conventional optimization method, when the model is fine-tuned for B after A, the important parameters of the task A are updated as little as possible, while the less important parameters of task A are updated with larger weights. The Fisher information matrix F, which is a diagonal matrix, is used to reduce the computational cost and to utilize characteristics of F, though it gives an approximation of the optimal parameters [symbol] (θ) for task A. The loss function of the second conventional optimization method [symbol] (θ) is as follows:

$$ℒ ( θ ) = {ℒ}_{B} ( θ ) + {\sum }_{i} \frac{λ}{2} {{F}_{i} ( {θ}_{i} - {θ}_{A , i}^{*} )}^{2} ,$$

where [symbol] (θ) is the task B's loss, λ sets how important the task A is compared with the task B, and i labels each parameter.

Experimental results of three different tasks are shown below: syntactic pre-training (the section entitled “Experiment 1: Syntactic Pre-training”), the General Language Understanding Evaluation (GLUE) benchmark (the section entitled “Experiment 2: GLUE”), and key phrase extraction (the section entitled “Experiment 3: Key Phrase Extraction”). The experimental results show how syntactic information and different optimization techniques affect the pre-trained model itself and downstream tasks. Note, references herein to “GLUE” should be understood to refer to exemplary embodiment(s) and attribution of certain features or characteristics to “GLUE” should not be construes to be required by all embodiments unless recited in the claims.

### Experiment 1: Syntactic Pre-Training

How well pre-trained models with semantic information can learn specific syntactic information by syntactic pre-training tasks (see the section entitled “Syntactic Pre-training Task” for detail) using various optimization functions while preserving semantic information is first shown.

### Settings

The syntactic pretraining system described in the section entitled “Syntactic Pre-training” was used. Bert-base-cased was adopted as the pre-trained model in the experiments described below. The disclosed embodiments were compared with Bert-base-cased without syntactic pre-training and the model with each of the four syntactic pre-training methods listed in the section entitled “Syntactic Pre-training.”

Four optimization functions, the first conventional optimization method, the second conventional optimization method, the conventional stochastic optimization method, and SGD, were used in the experiments. The first conventional optimization method and the second conventional optimization method prevent catastrophic forgetting as described in the section entitled “Optimization Functions to Prevent Catastrophic Forgetting.” The conventional stochastic optimization (SO) method and SGD were used as comparison.

In the model using the first conventional optimization method, the MLM (Masked Language Modeling) gradient was added to the syntactic pre-training one, i.e., multi-task training was performed with a small amount of MLM data. The model with the second conventional optimization method only used the MLM gradient to calculate the importance of the parameters, but was not additionally trained on MLM tasks in this phase. For training with the first conventional optimization method and the second conventional optimization method, 100 sentences were randomly selected from a conventional text database for each syntactic training step, and MLM gradient was computed.

The data for syntactic training was generated from a conventional English treebank. The sentences satisfying any of the following three conditions were removed as noise: 1) sentences with less than five tokens, 2) sentences containing foreign languages tagged as X, and 3) sentences containing undefined dependency relations labeled as dep. The number of sentences used in the experiment was the same across all tasks since these treatments were applied to all pre-training tasks. FIG. 2C is a table of sentences in the conventional English treebank corpus (after filtering) used for syntactic pre-training, in accordance with an example embodiment.

Precision, recall, and F1 score in the syntactic pre-training tasks were measured. To evaluate whether the model retains the original semantic knowledge, the pseudo-log-likelihood (PPL) score of the MLM was used. Multiple learning rates {1×10⁻⁴, 1×10⁻⁵, 1×10⁻⁶} and a multiple number of epochs {50, 70, 100} were used.

### Results

FIG. 2B is a table showing a comparison with different syntactic tasks and optimization functions in syntactic pre-training, in accordance with an example embodiment. (The row “none” means the baseline model without syntactic pre-training.) The highest average F1 scores of Syntax Head and Syntax Label predictions are reported. From the PPL scores, it is observed that the models trained with the first conventional optimization method and the second conventional optimization method learned syntactic information while retaining the semantic knowledge (low PPL), whereas the model with the conventional SO method and SGD suffered from catastrophic forgetting (high PPL).

The differences in performance due to the characteristics of each optimization function on syntactic learning are first described below. The pre-trained models using the conventional SO method achieved the highest average F1 scores compared with models using the other optimization functions. However, most syntactic pre-trained models achieved over 91% average F1 scores, except for the model trained with SGD on the coordination detection task, indicating that most models have sufficiently learned syntactic information. Note that there is a small difference in F1 scores between models trained with the conventional SO method and other optimization functions in the deprel task.

There was a significant difference between different optimizations in the PPL measure of MLM. The conventional SO method and SGD focus only on improving the performance of the target task (in this case, syntactic training); thus, they achieve high F1 scores in the target task while significantly degrading the previous task, which was indicated by high PPL scores. That is an example of catastrophic forgetting. Much lower PPL scores in the first conventional optimization method and the second conventional optimization method indicate that they retain semantic knowledge gained before syntactic pre-training.

Next, task-specific score differences are described. In terms of label scores in the conventional SO method, the main/subordinate and coordination detection tasks have high F1 scores due to the small number of label types, while the other tasks have low F1 scores. Given the nature of the data, this result is intuitive because the main/subordinate and coordination detection tasks have a small number of label types, but the other tasks have a large number of label types. Note that the head prediction is the same for all label tasks, but the head prediction score varies depending on the compatibility with the label task. For example, the combination of coordination detection and head prediction has a lower head F1 score than those of the others. Thus, it is better to choose a compatible combination when learning multiple syntactic information simultaneously.

### Experiment 2: GLUE

In this experiment, the effects of syntactic pre-trained models to multiple downstream tasks were investigated. Three binary classification tasks related to language comprehension from the GLUE benchmarking set were selected. The conventional decentralized training algorithm, RTE, and MRPC were selected. The conventional decentralized training algorithm determines whether an English sentence is grammatically correct, RTE is the entailment task between two sentences, and MRPC determines whether two sentences have the same meanings.

### Settings

The official data splits and pre-processings provided by GLUE were evaluated. Following the standard metrics in each task, Matthews correlation (MC) was used for the conventional decentralized training algorithm, accuracy (acc) was used for RTE, and accuracy and F1 score were used for MRPC. As the overall score for the disclosed methods, a macro-average of scores was taken for the three tasks; for MRPC, accuracy and F1 scores were averaged and then averaged with the other tasks. The number of epochs was set to five, and other parameters were set to conventional default parameters of the code. The performance on development data was compared since many submissions to the GLUE leaderboard can lead to identifying trends in the evaluation data.

### Results

FIG. 2D is a table showing performance comparisons of three GLUE tasks based on syntactic pre-training and optimization functions, in accordance with an example embodiment. (The highest score for each syntactic pre-training is underlined, and those for each GLUE task are shown in bold. The row “none” means the baseline model without syntactic pre-training.) For each pair of pre-training task and optimization function, the model which performed the best in terms of the average score of GLUE tasks was selected, rather than using the model which achieved the best in the syntactic pre-training tasks. The right block in the table of FIG. 2D shows their performance in the pre-training with Avg.F1 on syntactic tasks and PPL on MLM task, which are different from those reported in the table of FIG. 2B.

The models using the first conventional optimization method and the second conventional optimization method, which were introduced to prevent catastrophic forgetting, achieved higher scores, as expected, than those using the conventional SO method and SGD in the conventional decentralized training algorithm and MRPC tasks.

Among the four pre-trained models, coordination detection with the second conventional optimization method achieved the highest average score (72.22), and the other models also outperformed the score without syntactic pre-training (70.54). In other words, a variety of syntactic information contributed to the performance improvement.

In the following, the performance of each optimization function and each pre-training task are compared, regardless of the characteristics of the other, by taking the average score on each feature.

### Comparison of Optimization Function

FIG. 2E is a table showing a comparison of model average for each optimization function in three GLUE tasks and showing the model scores of each optimization function averaged over the four pre-training tasks shown in the table of FIG. 2D, in accordance with an example embodiment. The model pre-trained with the second conventional optimization method achieves higher scores on two tasks, and the model pre-trained with the first conventional optimization method has similar scores. That is, regardless of the type of syntactic pre-training task, learning syntax using the first conventional optimization method and the second conventional optimization method is effective to enhance the performance of the models.

As shown in the right block of the table of FIG. 2B, the first conventional optimization method and the second conventional optimization method preserve semantic information with small sacrifice of syntactic pre-training scores. In the trade-off relationship between these two, the table of FIG. 2E shows the strength of the first conventional optimization method and the second conventional optimization method in downstream tasks. It can be seen that models with good balance of original semantic information and newly acquired syntactic information showed high performance.

### Comparison of Syntactic Pre-Training

FIG. 2F is a table showing a comparison of model average for each syntactic pre-training in three GLUE tasks and showing the model scores of each pre-training task averaged over the optimization functions shown in the table of FIG. 2D, in accordance with an example embodiment.

In the conventional decentralized training task, coordination detection achieved the highest average score. This is explained using the annotation of grammatical features in a conventional linguistic development dataset. The performance of a conventional decentralized training algorithm has been compared in a previous work for sentences containing major features using development data. Thirteen grammatical major features were defined and further divided into 59 minor features; coordination is the most frequent minor feature in the major feature S-syntax. It was found that, in the BERT model, Matthew's correlation for sentences containing the S-syntax feature was second lowest among all major features. This indicates that the disclosed performance of the conventional decentralized training task was improved because models captured the coordination structures through additional syntactic pre-training.

The RTE task contains many long sentences, and it is considered that the main/subordinate pre-trained model handled long sentences better than other models.

For the MRPC task, the deprel achieved the highest average score. Previous works have suggested that MRPC requires information about words with various part-of-speech (PoS) tags via experiments in which models are trained by masking words of a specific POS tag in each of the GLUE tasks. (As a counter example, for a conventional image classification dataset (sentiment analysis), adjectives are much more effective than other PoS.) This deprel task learned more comprehensive syntactic information than the other tasks, which explains the disclosed result.

### Experiment 3: Key Phrase Extraction

In addition to binary classification tasks in GLUE, another experiment was conducted on the key phrase extraction task. It is a task to detect domain-specific phrases in sentences, and is considered to be a good workbench to test the ability to output syntactically correct sequences as an application close to real-world use cases.

### Settings

A conventional method that trained a phrase tagger using language models by generating silver labels from unlabeled text and using no external knowledge base nor dictionaries was used in the disclosed experiments. It was modified to work with BERT since their code worked with models using generative pre-trained transformer (GPT)-like tokenizers, such as robustly optimized BERT (ROBERTa). The number of epochs was set to 100. Other parameters and random seeds followed the default settings in the code.

Since many models were evaluated, a small version of a conventional dataset based on scholarly articles was used due to its reduced computational time. The conventional scholarly articles dataset was created from titles, abstracts, and key phrases of scientific articles in computer science. FIG. 2H is a table of the statistics in the conventional scholarly articles small dataset, in accordance with an example embodiment.

### Results

FIG. 2G is a table showing a performance comparison of a key phrase extraction task, in accordance with an example embodiment. (The row “none” means the baseline model without syntactic pre-training.) As well as in the experiments in the section entitled “Experiment 2: GLUE,” the syntactic pre-trained models were finetuned for this task.

All the syntactic pre-trained models achieved consistently higher F1 scores than the baseline by more than 1.4 points, regardless of the optimization methods. This indicates that a variety of syntactic information contributes to improve key phrase extraction, and the effect is bigger than in the binary classification tasks in GLUE.

In particular, phrase performed the best among the four syntactic pre-training methods. FIG. 2I is a table showing a comparison of average scores of syntactic pre-trained models in the key phrase extraction, in accordance with an example embodiment. (FIG. 2I clearly shows that phrase was the best in all three metrics.) As shown in the table of FIG. 2A, phrase has an intermediate granularity between deprel and main/subordinate, and it is intuitive that this matches well the syntactic knowledge required in the key phrase extraction task.

### Case Study

A qualitative analysis is presented for showing how added syntactic knowledge is reflected in the model outputs. The difference between the baseline model without syntactic pre-training and the pre-trained model with the phrase task was observed. Here, the latter model is called the phrase pre-trained model. The phrase pre-trained model using the first conventional optimization method achieved the best F1 score (as observed in the section entitled “Results”).

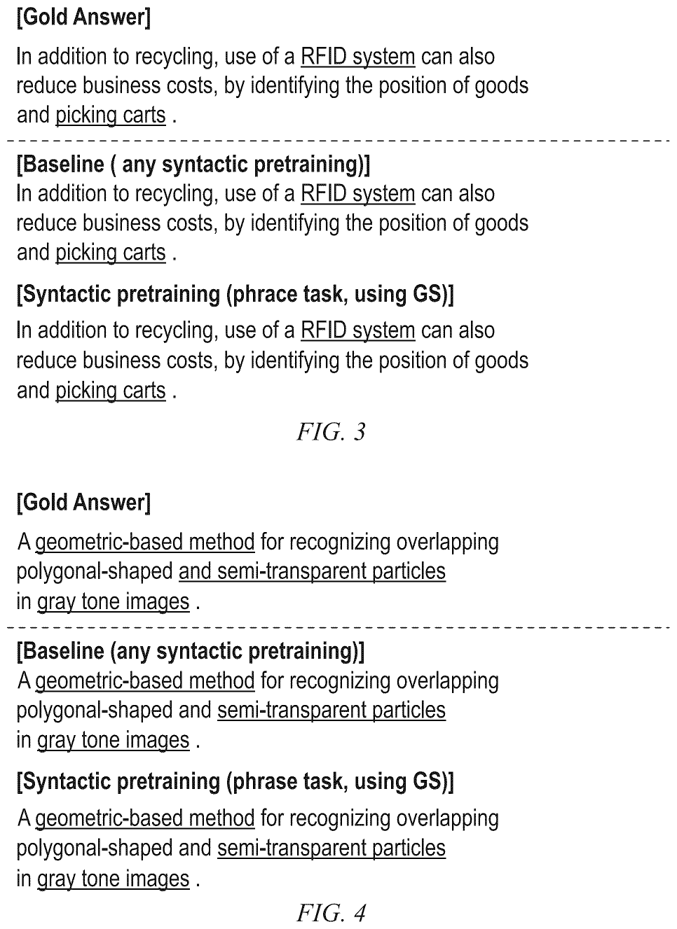

FIG. 3 is a first example phrase output, in accordance with an example embodiment. (The same phrase outputs among gold answer and two methods are blue-underlined; different phrase extractions are written in bold yellow. The wrong output is “reduce business costs.”) In FIG. 3, it can be seen that the baseline model incorrectly detected “reduce business costs.” as a key phrase, because it failed to recognize “reduce” as a verb in this sentence, resulting in a redundant word in the noun phrases. On the other hand, the phrase pre-trained model successfully detected “business costs.”

FIG. 4 is a second example phrase output, in accordance with an example embodiment. In FIG. 4, the baseline model incorrectly detected “recognizing overlapping” as a phrase. The phrase pre-trained model successfully avoided a phrase extraction error caused by a word whose grammatical behavior may be confused, in this case, between gerund and present progressive.

Given the discussion thus far, it will be appreciated that, in general terms, an exemplary method, according to an aspect of the invention, includes the operations of selecting, using at least one hardware processor, at least one syntactic pre-training task from among a set of syntactic pre-training tasks; retraining, for the selected at least one syntactic pre-training task and using the at least one hardware processor, the pre-trained language model by using an optimization function which prevents catastrophic forgetting during the retraining; and performing, using the at least one hardware processor, inferencing using the retrained language model.

In one example embodiment, the set of syntactic pre-training tasks are selected from a group consisting of a deprel prediction task, a phrase detection task, and a main/subordinate detection task.

In one example embodiment, the retraining further comprises learning at least one syntactic relationship between two tokens.

In one example embodiment, the set of syntactic pre-training tasks includes a coordination detection task for predicting a label of a parallel structure, wherein the parallel structure is one of a token, a phrase, and a sentence.

In one example embodiment, the label is a label of a head token, a child token, or a parallel conjunction of the corresponding parallel structure.

In one example embodiment, the set of syntactic pre-training tasks includes a deprel prediction task for predicting dependency labels.

In one example embodiment, the set of syntactic pre-training tasks includes a phrase detection task for predicting a relationship between phrases.

In one example embodiment, the set of syntactic pre-training tasks includes a main/subordinate detection task for predicting two labels to classify clauses into main and subordinate.

In one example embodiment, a dependency masking (DM), which predicts whether there is a dependency between two words, and a masked dependency prediction (MDP), which predicts a type of dependency relationship, are learned in parallel and input for the masked dependency prediction is replaced with one of the four syntactic pre-training tasks.

In one example embodiment, the optimization function is configured for solving gradient conflicts in multi-task learning and computes gradients for each task involved in multi-task learning, discards adversarial elements of the gradients that conflict with each other, and sums resultant gradients to obtain a single gradient vector.

In one example embodiment, the optimization function is configured for continuous learning optimization in which tasks are learned in sequence and, given two tasks, A and B, first searches for an optimal solution for task A, then searches for parameters that perform well in both tasks A and B and, when the model is fine-tuned for B after A, updates more important parameters of the task A with smaller weights while updating less important parameters of the task A with larger weights.

In one example embodiment, the retrained language model is applied to a downstream task to perform inferencing for language understanding.

In one aspect, a computer program product comprises one or more tangible computer-readable storage media and program instructions stored on at least one of the one or more tangible computer-readable storage media, the program instructions executable by a processor, the program instructions comprising selecting at least one syntactic pre-training task from among a set of syntactic pre-training tasks; retraining, for the selected at least one syntactic pre-training task, the pre-trained language model by using an optimization function which prevents catastrophic forgetting during the retraining; and performing inferencing using the retrained language model.

In one aspect, an apparatus comprises a memory and at least one processor, coupled to the memory, and operative to perform operations comprising selecting at least one syntactic pre-training task from among a set of syntactic pre-training tasks; retraining, for the selected at least one syntactic pre-training task, the pre-trained language model by using an optimization function which prevents catastrophic forgetting during the retraining; and performing inferencing using the retrained language model.

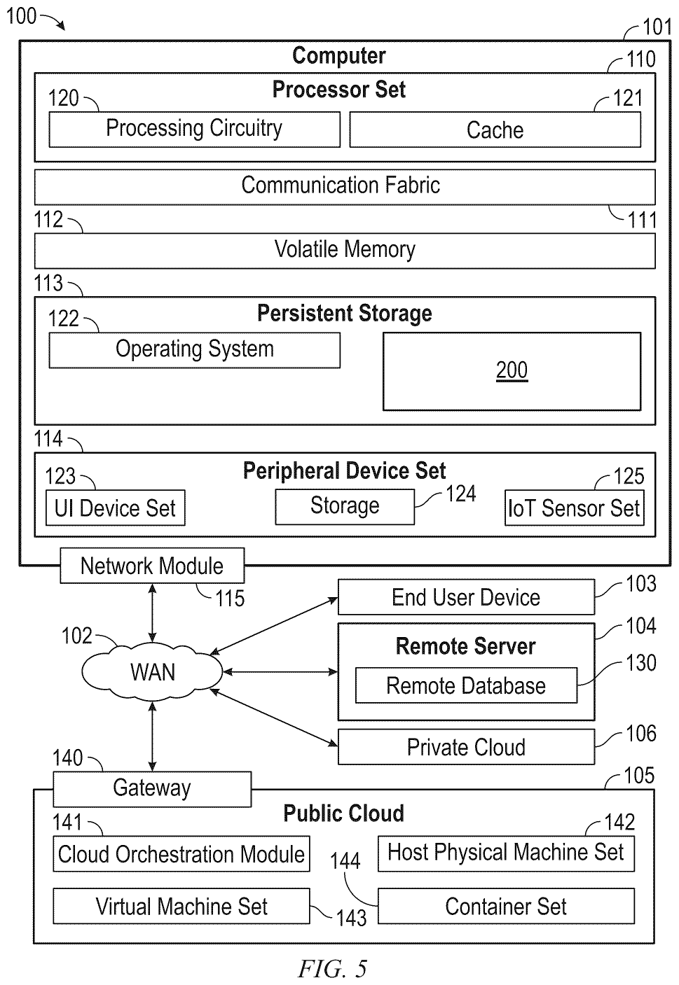

Refer now to FIG. 5.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as machine learning system 200 which incorporates syntactic knowledge into a pre-trained language model according to aspects of the invention. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for incorporating syntactic knowledge into a pre-trained language model, the method comprising:
selecting, using at least one hardware processor, at least one syntactic pre-training task from among a set of syntactic pre-training tasks;
retraining, for the selected at least one syntactic pre-training task and using the at least one hardware processor, the pre-trained language model by using an optimization function which prevents catastrophic forgetting during the retraining; and
performing, using the at least one hardware processor, inferencing using the retrained language model.

2. The method of claim 1, wherein the set of syntactic pre-training tasks are selected from a group consisting of a deprel prediction task, a phrase detection task, and a main/subordinate detection task.

3. The method of claim 1, wherein the retraining further comprises learning at least one syntactic relationship between two tokens.

4. The method of claim 1, wherein the set of syntactic pre-training tasks includes a coordination detection task for predicting a label of a parallel structure, wherein the parallel structure is one of a token, a phrase, and a sentence.

5. The method of claim 4, wherein the label is a label of a head token, a child token, or a parallel conjunction of the corresponding parallel structure.

6. The method of claim 1, wherein the set of syntactic pre-training tasks includes a deprel prediction task for predicting dependency labels.

7. The method of claim 1, wherein the set of syntactic pre-training tasks includes a phrase detection task for predicting a relationship between phrases.

8. The method of claim 1, wherein the set of syntactic pre-training tasks includes a main/subordinate detection task for predicting two labels to classify clauses into main and subordinate.

9. The method of claim 1, further comprising learning, in parallel, a dependency masking (DM), which predicts whether there is a dependency between two words, and a masked dependency prediction (MDP), which predicts a type of dependency relationship, and wherein input for the masked dependency prediction is replaced with one of the four syntactic pre-training tasks.

10. The method according to claim 1, wherein the optimization function is configured for solving gradient conflicts in multi-task learning and computes gradients for each task involved in multi-task learning, discards adversarial elements of the gradients that conflict with each other, and sums resultant gradients to obtain a single gradient vector.

11. The method according to claim 1, wherein the optimization function is configured for continuous learning optimization in which tasks are learned in sequence and, given two tasks, A and B, first searches for an optimal solution for task A, then searches for parameters that perform well in both tasks A and B and, when the model is fine-tuned for B after A, updates more important parameters of the task A with smaller weights while updating less important parameters of the task A with larger weights.

12. The method of claim 1, further comprising applying the retrained language model to a downstream task to perform inferencing for language understanding.

13. A computer program product, comprising:
one or more tangible computer-readable storage media and program instructions stored on at least one of the one or more tangible computer-readable storage media, the program instructions executable by a processor, the program instructions comprising:
selecting at least one syntactic pre-training task from among a set of syntactic pre-training tasks;
retraining, for the selected at least one syntactic pre-training task, the pre-trained language model by using an optimization function which prevents catastrophic forgetting during the retraining; and
performing inferencing using the retrained language model.

14. A system comprising:
a memory; and
at least one processor, coupled to said memory, and operative to perform operations comprising:
selecting at least one syntactic pre-training task from among a set of syntactic pre-training tasks;
retraining, for the selected at least one syntactic pre-training task, the pre-trained language model by using an optimization function which prevents catastrophic forgetting during the retraining; and
performing inferencing using the retrained language model.

15. The system of claim 14, wherein the retraining further comprises learning at least one syntactic relationship between two tokens.

16. The system of claim 14, wherein the set of syntactic pre-training tasks includes a coordination detection task for predicting a label of a parallel structure, wherein the parallel structure is one of a token, a phrase, and a sentence.

17. The system of claim 14, the operations further comprising learning, in parallel, a dependency masking (DM), which predicts whether there is a dependency between two words, and a masked dependency prediction (MDP), which predicts a type of dependency relationship, and wherein input for the masked dependency prediction is replaced with one of the four syntactic pre-training tasks.

18. The system of claim 14, wherein the optimization function is configured for solving gradient conflicts in multi-task learning and computes gradients for each task involved in multi-task learning, discards adversarial elements of the gradients that conflict with each other, and sums resultant gradients to obtain a single gradient vector.

19. The system of claim 14, wherein the optimization function is configured for continuous learning optimization in which tasks are learned in sequence and, given two tasks, A and B, first searches for an optimal solution for task A, then searches for parameters that perform well in both tasks A and B and, when the model is fine-tuned for B after A, updates more important parameters of the task A with smaller weights while updating less important parameters of the task A with larger weights.

20. The system of claim 14, the operations further comprising applying the retrained language model to a downstream task to perform inferencing for language understanding.
